(19) United States
(12) Patent Application Publication
(10) Pub. No.: US 2004/0167033 A1
(43) Pub. Date: Aug. 26, 2004

(54) Herbicidal composition

(76) Inventors: Mike Johnson, Greensboro, NC (US); Willy T. Ruegg, Stein (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/480,864

(22) PCT Filed: Jun. 12, 2002
(86) PCT No.: PCT/EP02/06463

(30) Foreign Application Priority Data
Jun. 13, 2001 (CH) 1064/01

(51) Int. Cl. A01N 63/00; A01N 43/10; A01N 33/00

(52) U.S. Cl. 504/326; 504/289

(57) ABSTRACT

Selectively herbicidal composition for controlling grasses and weeds in crops of useful plants comprising a) a herbicidally effective amount of a compound of formula (I, and b) an amount, effective for herbicide antagonism, of the compound of formula (II), wherein the substituents have the meanings given in claim 1.

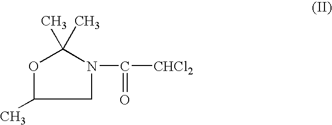

The present invention relates to novel selectively herbicidal compositions for controlling grasses and weeds in crops of useful plants, especially in crops of maize, which compositions comprise a herbicide and a safener (counter-agent, antidote) and protect the useful plants, but not the weeds, against the phytotoxic action of the herbicide, and to the use of such a composition in controlling weeds in crops of useful plants.

When using herbicides, the cultivated plants may also suffer considerable damage, depending, for example, on the amount of herbicide used and the method of application, the cultivated plant, the nature of the soil and climatic conditions, for example period of exposure to light and amounts of rainfall. In order to deal with that and similar problems, various substances have already been proposed as safeners, which are capable of antagonising the harmful effect of the herbicide on the cultivated plant, that is to say are capable of protecting the cultivated plant, without appreciably impairing the herbicidal action on the weeds to be controlled. It has been demonstrated that the proposed safeners often act very specifically with respect to the cultivated plants and with respect to the herbicide and in some cases also in dependence on the method of application. This means that a specific safener is often suitable only for a specific cultivated plant and a particular class of herbicidal substance or a specific herbicide. For example, compounds are known from EP-A-685 157 which protect cultivated plants against the phytotoxic action of herbicides, such as, for example, S-metolachlor.

It has now been found that the compound of formula 11

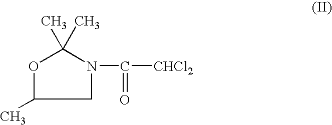

is suitable for the protection of cultivated plants against the phytotoxic action of a certain class of acetanilide herbicides.

In accordance with the invention a selectively herbicidal composition is accordingly proposed that, in addition to customary inert formulation adjuvants, such as carriers, solvents and wetting agents, comprises as active ingredient a mixture of a) a herbicidally effective amount of a herbicide of formula I

Z—NR₁R₂ (I),

wherein Z is a radical of formula

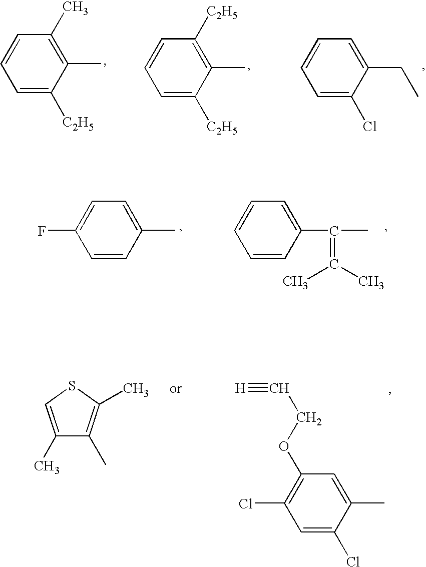

R₁ is a radical of formula —CH(CH₃)₂, —CH(CH₃)—CH₂OCH₃, —C*H(CH₃)—CH₂OCH₃, —CH₂CH₂—O—CH₂CH₃, —CH₂OC₂H₅ or —CH₂OCH₃ and

R₂ is a radical of formula

—C(O)—CH₂Cl

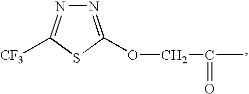

or

R₁ and R₂ together form a radical of formula

—C(O)13 C(CH₃)₂—CH₂—O—or

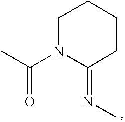

and

b) an amount, effective for herbicide antagonism, of the safener of formula II

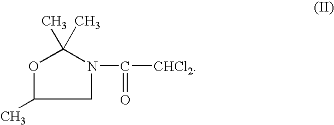

The invention relates also to a method of selectively controlling weeds in crops of useful plants, which method comprises treating the useful plants, their seeds or cuttings or the area of cultivation thereof, simultaneously or separately, with a herbicidally effective amount of the herbicide of formula I and with an amount, effective for herbicide antagonism, of the safener of formula II.

Cultivated plants that may be protected against the harmful effect of the above-mentioned herbicides by means of the safener of formula II are especially maize and cereals, preferably maize. Crops are to be understood as including also those that have been made tolerant to herbicides or classes of herbicides by means of conventional breeding or genetic engineering methods.

The weeds to be controlled may be either monocotyledonous or dicotyledonous weeds, for example Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, lpomoea, Chrysanthemum, Galium, Viola and Veronica.

Areas of cultivation are areas of land on which the cultivated plants are already growing or in which the seeds of those cultivated plants have been sown, and also areas of land on which it is intended to grow those cultivated plants.

The safener of formula II may, depending on the intended purpose, be used to pre-treat the seeds of the cultivated plant (dressing the seed or the cuttings) or may be incorporated into the soil before or after sowing. It may, however, also be applied, alone or together with the herbicide after the emergence of the plants. The treatment of the plants or seed with the safener can therefore, in principle, be effected independently of the time at which the herbicide is applied. The treatment of the plants can, however, also be carried out by applying the herbicide and safener simultaneously (for example in the form of a tank mixture). The rate of application of the safener in relation to the herbicide depends largely on the method of application. In the case of field treatment, which is effected either using a tank mixture comprising a combination of the safener and the herbicide or by the separate application of the safener and the herbicide, the ratio of herbicide to safener is preferably from 1:1 to 1:30.

A preferred procedure comprises treating the cultivated plants, seeds or cuttings thereof or the area of cultivation thereof first with a mixture of the compounds of formulae I and II and then with a co-herbicide. Also preferred is treatment of the cultivated plants, seeds or cuttings thereof or the area of cultivation thereof first with a mixture of the compounds of formulae I and 11 and a co-herbicide, and then with another co-herbicide.

The compounds of formula I are preferably metolachlor, S-metolachlor (containing the group —C*H(CH₃)—CH₂OCH₃), alachlor, acetochlor, flufenacet, dimethenamid and P-dimethenamid and also pethoxamid. Metolachlor, S-metolachlor and acetochlor are especially preferred.

The following may be mentioned as suitable co-herbicides that may be present in the compositions according to the invention: atrazine, terbuthylazine, simazine, flumetsulam, metosulam, pendimethalin, clopyralid, dicamba, dicamba and diflufenzopyr, tritosulfuron, nicosulfuron, primisulfuron, prosulfuron, rimsulfuron, halosulfuron, foramsulfuron, foramsulfuron and isoxadifen, diclosulam, mesotrione, isoxaflutole, diflufenzopyr, amicarbazone or the compound of formula III

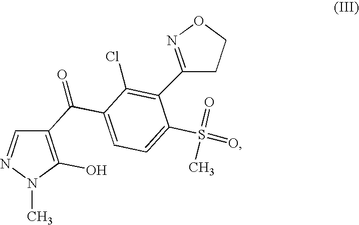

preference being given to atrazine, terbuthylazine, simazine, flumetsulam, metosulam, pendimethalin, clopyralid, dicamba, dicamba and diflufenzopyr, rimsulfuron, halosulfuron, diclosulam, mesotrione, isoxaflutole, diflufenzopyr and amicarbazone.

Further suitable co-herbicides that may be mentioned are: terbutryne, metribuzin, pyridate, pyridafol, propoxycarbazone, glufosinate, D-glufosinate, glyphosate, sulfosate, butafenacil, butafenacil and glyphosate, fluthiacet, imazamox, imazethapyr, cloransulam, florasulam, bromoxynil, ioxynil, carfentrazone, sulfentrazone, sulcotrione, isoxachlortole, bentazone, EPTC, butylate, fentrazamide, isopropazole, aclonifen, cinidon-ethyl, flumioxacin and glyphosate, clomazone, 2,4-D, flumiclorac, sethoxydim, tepraloxydim, clethodim, imazaquin, imazapyr, thifensulfuron, prosulfuron and primisulfuron, iodosulfuron, iodosulfuron and isoxadifen, prohexadione, flurtamone, flumioxacin, benzfendizone, fluazolate, flufenpyr-ethyl, mesosulfuron, trifloxysulfuron and penoxsulam.

Preferred compositions according to the present invention comprise as active ingredient a mixture A consisting of metolachlor and the compound of formula II.

Compositions of active ingredient and co-herbicide that have proved especially suitable are those comprising:

as active ingredient the mixture A and as co-herbicide nicosulfuron, rimsulfuron, mesotrione, prosulfuron, primisulfuron, foramsulfuron, tritosulfuron, halosulfuron or the compound of formula III;

as active ingredient the mixture B consisting of metolachlor, the compound of formula II and atrazine;

as active ingredient the mixture B and as co-herbicide nicosulfuron, rimsulfuron, mesotrione, prosulfuron, primisulfuron, foramsulfuron, tritosulfuron, halosulfuron or the compound of formula II;

as active ingredient the mixture C consisting of metolachlor, the compound of formula II and terbuthylazine;

as active ingredient the mixture C and as co-herbicide nicosulfuron, rimsulfuron, mesotrione, prosulfuron, primisulfuron, foramsulfuron, tritosulfuron, halosulfuron or the compound of formula III;

as active ingredient the mixture D consisting of metolachlor, the compound of formula II and simazine;

as active ingredient the mixture D and as co-herbicide nicosulfuron, rimsulfuron, mesotrione, prosulfuron, primisulfuron, foramsulfuron, tritosulfuron, halosulfuron or the compound of formula III;

as active ingredient the mixture E consisting of metolachlor, the compound of formula II and flumetsulam;

as active ingredient the mixture E and as co-herbicide nicosulfuron, rimsulfuron, mesotrione, prosulfuron, primisulfuron, foramsulfuron, tritosulfuron, halosulfuron or the compound of formula III;

as active ingredient the mixture F consisting of metolachlor, the compound of formula II and metosulam;

as active ingredient the mixture F and as co-herbicide nicosulfuron, rimsulfuron, mesotrione, prosulfuron, primisulfuron, foramsulfuron, tritosulfuron, halosulfuron or the compound of formula III;

as active ingredient the mixture G consisting of metolachlor, the compound of formula II and pendimethalin;

as active ingredient the mixture G and as co-herbicide nicosulfuron, rimsulfuron, mesotrione, prosulfuron, primisulfuron, foramsulfuron, tritosulfuron, halosulfuron or the compound of formula III;

as active ingredient the mixture H consisting of metolachlor, the compound of formula II and isoxaflutole;

as active ingredient the mixture H and as co-herbicide nicosulfuron, rimsulfuron, mesotrione, prosulfuron, primisulfuron, foramsulfuron, tritosulfuron, halosulfuron or the compound of formula III;

as active ingredient the mixture I consisting of metolachlor, the compound of formula II and mesotrione;

as active ingredient the mixture I and as co-herbicide nicosulfuron, rimsulfuron, mesotrione, prosulfuron, primisulfuron, foramsulfuron, tritosulfuron, halosulfuron or the compound of formula III;

as active ingredient the mixture J consisting of metolachlor, the compound of formula II and clopyralid;

as active ingredient the mixture J and as co-herbicide nicosulfuron, rimsulfuron, mesotrione, prosulfuron, primisulfuron, foramsulfuron, tritosulfuron, halosulfuron or the compound of formula III;

as active ingredient the mixture K consisting of metolachlor, the compound of formula II and dicamba;

as active ingredient the mixture K and as co-herbicide nicosulfuron, rimsulfuron, mesotrione, prosulfuron, primisulfuron, foramsulfuron, tritosulfuron, halosulfuron or the compound of formula III;

as active ingredient the mixture L consisting of metolachlor, the compound of formula II, dicamba and diflufenzopyr;

as active ingredient the mixture L and as co-herbicide nicosulfuron, rimsulfuron, mesotrione, prosulfuron, primisulfuron, foramsulfuron, tritosulfuron, halosulfuron or the compound of formula III;

as active ingredient the mixture M consisting of metolachlor, the compound of formula II and diclosulam;

as active ingredient the mixture M and as co-herbicide nicosulfuron, rimsulfuron, mesotrione, prosulfuron, primisulfuron, foramsulfuron, tritosulfuron, halosulfuron or the compound of formula III;

as active ingredient the mixture N consisting of metolachlor, the compound of formula II and halosulfuron;

as active ingredient the mixture N and as co-herbicide nicosulfuron, rimsulfuron, mesotrione, prosulfuron, primisulfuron, foramsulfuron, tritosulfuron, halosulfuron or the compound of formula III;

as active ingredient the mixture O consisting of metolachlor, the compound of formula II and amicarbazone;

as active ingredient the mixture O and as co-herbicide nicosulfuron, rimsulfuron, mesotrione, prosulfuron, primisulfuron, foramsulfuron, tritosulfuron, halosulfuron or the compound of formula III;

as active ingredient the mixture P consisting of metolachlor, the compound of formula II and rimsulfuron;

as active ingredient the mixture P and as co-herbicide nicosulfuron, rimsulfuron, mesotrione, prosulfuron, primisulfuron, foramsulfuron, tritosulfuron, halosulfuron or the compound of formula III.

Further especially suitable compositions comprise the herbicide S-metolachlor instead of metolachlor.

A further group of preferred compositions comprises the herbicide acetochlor instead of metolachlor.

Other preferred compositions comprise the herbicide alachlor instead of metolachlor.

Again, other preferred compositions comprise the herbicide flufenacet instead of metolachlor.

Compositions comprising the herbicide dimethenamid instead of metolachlor are likewise preferred, as are compositions comprising the herbicide S-dimethanamid instead of metolachlor.

A further preferred composition comprises the herbicide pethoxamid instead of metolachlor.

The compounds of formulae I and II used in accordance with the invention as well as the mentioned co-herbicides are known from The Pesticide Manual, Twelfth Edition, 2000. Benzfendizone is known from U.S. Pat. No. 6 136 972; flufenpyr is known from WO 98/35559; foramsulfuron and mesosulfuron are known from WO 01/301056; tritosulfuron is known from WO 98/34482; isoxadifen is known from WO 01/17350; isoxachlortole is known from WO 00/08936; fentrazamide is known from WO 01/22819; isopropazole is known from WO 96/02515; R-29148 is known from Holt et al, Planta 196, 295-302 (1995), pethoxamid is known from WO 0018932.

In the case of field treatment, generally from 0.001 to 5.0 kg of safener/ha, and preferably from 0.001 to 0.5 kg of safener/ha, are applied. The rate of application of herbicide is generally from 0.001 to 2 kg/ha, but preferably from 0.005 to 1 kg/ha.

The compositions according to the invention are suitable for all methods of application that are customary in agriculture, for example pre-emergence application, post-emergence application and seed dressing. In the case of seed dressing, generally from 0.001 to 10 9 of safener/kg of seed, preferably from 0.05 to 2 g of safener/kg of seed, are applied. If the safener is applied in liquid form, by seed soaking, shortly before sowing, it is advantageous to use safener solutions containing the active ingredient in a concentration of from 1 to 10 000 ppm, preferably from 10 to 1000 ppm.

For application, the safener of formula II or combinations of that safener with the herbicides of formula I are advantageously processed, together with the adjuvants customary in formulation technology, into formulations, for example into emulsifiable concentrates, coatable pastes, directly sprayable or dilutable solutions, dilute emulsions, wettable powders, soluble powders, dusts, granules or microcapsules. Such formulations are described, for example, in WO 97/34485, on pages 9 to 13. The formulations are prepared in known manner, for example by intimately mixing and/or grinding the active ingredients with liquid or solid formulation adjuvants, for example solvents or solid carriers. Furthermore, surface-active compounds (surfactants) may additionally be used in the preparation of the formulations. Solvents and solid carriers that are suitable for that purpose are mentioned, for example, in WO 97/34485 on page 6.

Suitable surface-active compounds are, depending on the nature of the active ingredient of formula I being formulated, non-ionic, cationic and/or anionic surfactants and mixtures of surfactants having good emulsifying, dispersing and wetting properties. Examples of suitable anionic, non-ionic and cationic surfactants are listed, for example, in WO 97/34485 on pages 7 and 8. Furthermore, the surfactants customarily employed in formulation technology, which are described, inter alia, in “Mc Cutcheon's Detergents and Emulsifiers Annual” MC Publishing Corp., Ridgewood N.J., 1981, Stache, H., “Tensid-Taschenbuch”, Carl Hanser Verlag, MunichNienna, 1981 and M. and J. Ash, “Encyclopedia of Surfactants”, Vol I-III, Chemical Publishing Co., New York, 1980-81, are also suitable for preparation of the herbicidal compositions according to the invention.

The herbicidal formulations generally contain from 0.1 to 99% by weight, especially from 0.1 to 95% by weight, of active ingredient mixture comprising the compound of formula I together with the compound of formula II, from I to 99.9% by weight of a solid or liquid formulation adjuvant and from 0 to 25% by weight, especially from 0.1 to 25% by weight, of a surfactant. Whereas commercial products will preferably be formulated as concentrates, the end user will normally employ dilute formulations.

The compositions may also comprise further additives such as stabilisers, for example vegetable oils or epoxidised vegetable oils (epoxidised coconut oil, rapeseed oil or soybean oil), antifoams, for example silicone oil, preservatives, viscosity regulators, binders and tackifiers, as well as fertilisers or other active ingredients. There are various suitable methods and techniques for using the safener of formula II or compositions comprising it for protecting cultivated plants against harmful effects of herbicides of formula I; the following are examples:

i) Seed Dressing

a) Dressing the seeds with a wettable powder formulation of the active ingredient of formula II by shaking in a vessel until the formulation is uniformly distributed over the seed surface (dry dressing). Approximately from 1 to 500 g of active ingredient of formula II (from 4 g to 2 kg of wettable powder) are used per 100 kg of seed.

b) Dressing the seeds with an emulsifiable concentrate of the active ingredient of formula II according to method a) (wet dressing).

c) Dressing by immersing the seed in a liquid formulation containing from 100 to 1000 ppm of the active ingredient of formula II for from 1 to 72 hours and, if desired, subsequently drying the seeds (immersion dressing).

Dressing the seed or treating the germinated seedlings are naturally the preferred methods of application because the treatment with the active ingredient is directed wholly at the target crop. Generally from I to 1000 g of antidote, preferably from 5 to 250 g of antidote, are used per 100 kg of seed, although, depending on the method employed, which also allows the addition of other active ingredients or micronutrients, amounts that exceed or fall short of the specified concentration limits may be employed (repeat dressing).

ii) Application in the Form of a Tank Mixture

A liquid formulation of a mixture of antidote and herbicide and optionally the co-herbicides (in a respective quantity ratio of from 10:1 to 1:100) is used, the rate of application of herbicide being from 0.005 to 5.0 kg per hectare. Such tank mixtures are applied before or after sowing.

iii) Application to the Seed Furrow

The active ingredient of formula II is introduced into the open, sown seed furrow in the form of an emulsifiable concentrate, a wettable powder or granules. After the seed furrow has been covered, the herbicide is applied by the pre-emergence method in the normal manner.

iv) Controlled Release of the Active Ingredient

The active ingredient of formula II is applied in solution to granulated mineral carriers or polymerised granules (urea-formaldehyde) and dried. If desired, a coating may be applied (coated granules) which enables the active ingredient to be released in metered amounts over a predetermined period of time.

Preferred formulations have especially the following compositions (% =percent by weight; ‘active ingredient mixture’ denotes the mixture of the compound of formula I and optionally the co-herbicides with the compound of formula II):

| | |
|---|---|
| Emulsifiable | |
| concentrates: | |
| active ingredient mixture: | from 1 to 90%, preferably from 5 to 20% |
| surface-active agent: | from 1 to 30%, preferably from 10 to 20% |
| liquid carrier: | from 5 to 94%, preferably from 70 to 85% |
| Dusts: | |
| active ingredient mixture: | from 0.1 to 10%, preferably from 0.1 to 5% |
| solid carrier: | from 99.9 to 90%, preferably from 99.9 to 99% |
| Suspension concentrates: | |
| active ingredient mixture: | from 5 to 75%, preferably from 10 to 50% |
| water: | from 94 to 24%, preferably from 88 to 30% |
| surface-active agent: | from 1 to 40%, preferably from 2 to 30% |
| Wettable powders: | |
| active ingredient mixture: | from 0.5 to 90%, preferably from 1 to 80% |
| surface-active agent: | from 0.5 to 20%, preferably from 1 to 15% |
| solid carrier: | from 5 to 95%, preferably from 15 to 90% |
| Granules: | |
| active ingredient mixture: | from 0.1 to 30%, preferably from 0.1 to 15% |
| solid carrier: | from 99.5 to 70%, preferably from 97 to 85% |

The Examples that follow illustrate the invention further without limiting the invention.

Formulation Examples for Mixtures of Herbicides of Formula I and Optionally the Co-herbicides and Safener of Formula II (% =Percent by Weight)

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol-polyglycol ether | — | 4% | — | 2% |
| (7-8 mol of ethylene oxide) | | | | |
| cyclohexanone | — | — | 10% | 20% |
| aromatic C₉-C₁₂hydrocarbon mixture | 85% | 78% | 55% | 16% |

Emulsions of any desired concentration can be prepared from such concentrates by dilution with water.

| | a) | b) | c) | d) |
|---|---|---|---|---|
| F2. Solutions | | | | |
| active ingredient mixture | 5% | 10% | 50% | 90% |
| 1-methoxy-3-(3-methoxy- | — | 20% | 20% | — |
| propoxy)-propane | | | | |
| polyethylene glycol (mol. wt. 400) | 20% | 10% | — | — |
| N-methyl-2-pyrrolidone | — | — | 30% | 10% |
| aromatic C₉-C₁₂hydrocarbon mixture | 75% | 60% | — | — |
| The solutions are suitable | | | | |
| for application in the | | | | |
| form of micro-drops. | | | | |
| F3. Wettable powders | | | | |
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalenesulfonate | — | 6% | 5% | 6% |
| octylphenol-polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier material | 99.0% | 93% | 83% |
| (diameter 0.1-1 mm) | | | |
| for example CaCO₃ or SiO₂ | | | |

The active ingredient is dissolved in methylene chloride, the solution is sprayed onto the carrier, and the solvent is subsequently evaporated off in vacuo.

| F5. Coated granules | a) | b) | c) |
|---|---|---|---|
| active ingredient mixture | 0.1% | 5% | 15% |
| polyethylene glycol (mol. wt. 200) | 1.0% | 2% | 3% |
| highly dispersed silicic acid | 0.9% | 1% | 2% |
| inorganic carrier material | 98.0% | 92% | 80% |
| (diameter 0.1-1 mm) | | | |
| for example CaCO₃ or SiO₂ | | | |

The finely ground active ingredient is uniformly applied, in a mixer, to the carrier material moistened with polyethylene glycol, yielding non-dusty coated granules.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed with the adjuvants, and the mixture is ground, moistened with water, extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol-polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde solution | 0.2% | 0.2% | 0.2% | 0.2% |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical to formulate the active ingredient of formula I and optionally the co-herbicides and the mixing partner of formula II separately and then, shortly before application, to bring them together in the applicator in the desired mixing ratio in the form of a “tank mixture”.

The ability of the safener of formula II to protect cultivated plants against the phytotoxic action of herbicides of formula I is illustrated in the following Examples.

### BIOLOGICAL EXAMPLES

### Example B1: Post-emergence Test

The test plants are grown in pots under greenhouse conditions until the post-application stage. A standard soil is used as cultivation substrate. At a post-emergence stage, the herbicides, both on their own and in admixture with safener, are applied to the test plants or to cultivated plants seed-dressed with safener. The rates of application depend on the optimum doses ascertained under field conditions or greenhouse conditions. The tests are evaluated after from 2 to 4 weeks (100% action=complete destruction, 0% action=no phytotoxic action). The mixtures used in this test show good results.

### Example B2: Pre-emergence Test

The test plants are sown in pots under greenhouse conditions. A standard soil is used as cultivation substrate. At a pre-emergence stage, the herbicides, both on their own and in admixture with safener, are applied to the soil surface or to cultivated plants seed-dressed with safener. The rates of application depend on the optimum doses ascertained under field conditions or greenhouse conditions. The tests are evaluated after from 2 to 4 weeks (100% action=complete destruction, 0% action=no phytotoxic action). The mixtures used in this test show good results.

TABLE B2.1
Pre-emergence action of metolachlor (EC 960) on maize

| | | | | |
|---|---|---|---|---|
| Herbicide: S-metolachlor | 6000 | 4000 | 2000 | 1000 |
| rate of application (g/ha): | | | | |
| Safener of formula II | 6000 | 4000 | 2000 | 1000 |
| rate of application (g/ha): | | | | |
| Phytotoxicity on maize (%) | 53 | 40 | 20 | 7 |
| 15 days after application | | | | |

TABLE B2.2
Pre-emergence action of the mixture of S-metolachlor
(EC 960) and safener of formula II (WP 25) on maize

| | | | | |
|---|---|---|---|---|
| Herbicide: S-metolachlor | 6000 | 4000 | 2000 | 1000 |
| rate of application (g/ha): | | | | |
| Safener of formula II | 6000 | 4000 | 2000 | 1000 |
| rate of application (g/ha): | | | | |
| Phytotoxicity on maize (%) | 18 | 13 | 15 | 12 |
| 15 days after application | | | | |

TABLE B2.3
Pre-emergence action of the mixture of S-metolachlor
(EC 960) and safener of formula II (WP 25) on maize

| | | | | |
|---|---|---|---|---|
| Herbicide: S-metolachlor | 6000 | 4000 | 2000 | 1000 |
| rate of application (g/ha): | | | | |
| Safener of formula II | 600 | 400 | 200 | 100 |
| rate of application (g/ha): | | | | |
| Phytotoxicity on maize (%) | 15 | 8 | 3 | 0 |
| 15 days after application | | | | |

TABLE B2.4
Pre-emergence action of the mixture of S-metolachlor
(EC 960) and safener of formula II (WP 25) on maize

| | | | | |
|---|---|---|---|---|
| Herbicide: S-metolachlor | 6000 | 4000 | 2000 | 1000 |
| rate of application (g/ha): | | | | |
| Safener of formula II | 300 | 200 | 100 | 50 |
| rate of application (g/ha): | | | | |
| Phytotoxicity on maize (%) | 12 | 7 | 0 | 0 |
| 15 days after application | | | | |

TABLE B2.5
Pre-emergence action of the mixture of S-metolachlor
(EC 960) and safener of formula II (WP 25) on maize

| | | | | |
|---|---|---|---|---|
| Herbicide: S-metolachlor | 6000 | 4000 | 2000 | 1000 |
| rate of application (g/ha): | | | | |
| Safener of formula II | 200 | 133 | 66 | 33 |
| rate of application (g/ha): | | | | |
| Phytotoxicity on maize (%) | 12 | 3 | 3 | 0 |
| 15 days after application | | | | |

The same results are obtained when the active ingredient mixture is formulated in accordance with the other formulation examples mentioned above.

What is claimed is:

1. A selectively herbicidal composition that, in addition to customary inert formulation adjuvants, comprises as active ingredient a mixture of a) a herbicidally effective amount of a herbicide of formula I
Z—NR₁R₂ (I).
wherein Z is a radical of formula 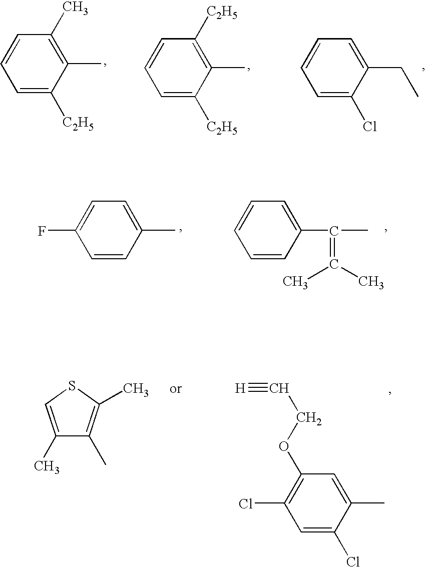
R₁ is a radical of formula —CH(CH₃)₂, —CH(CH₃)—CH₂)CH₃, —C*H(CH₃)—CH₂OCH₃, —CH₂CH₂—O—CH₂CH₃, —CH₂OC₂H₅ or —CH₂OCH₃ and
R₂ is a radical of formula 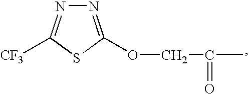
—C(O)—CH₂Cl
or 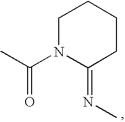
R₁ and R₂ together form a radical of formula
—C(O)—C(CH₃)₂—CH₂—O—or
and
b) an amount, effective for herbicide antagonism, of the safener of formula II

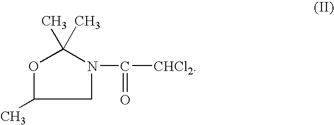

2. A composition according to claim 1 that comprises as compound of formula I metolachlor, S-metolachlor, alachlor, acetochlor, flufenacet, dimethenamid, P-dimethenamid or pethoxamid.

3. A composition according to claim 2 that comprises as compound of formula I metolachlor, S-metolachlor or acetochlor.

4. A composition according to claim 1 that comprises a co-herbicide.

5. A composition according to claim 4 that comprises as co-herbicide atrazine, terbuthylazine, simazine, flumetsulam, metosulam, pendimethalin, clopyralid, dicamba, dicamba and diflufenzopyr, tritosulfuron, nicosulfuron, primisulfuron, prosulfuron, rimsulfuron, halosulfuron, foramsulfuron, foramsulfuron and isoxadifen, diclosulam, mesotrione, isoxaflutole, diflufenzopyr, amicarbazone or the compound of formula III

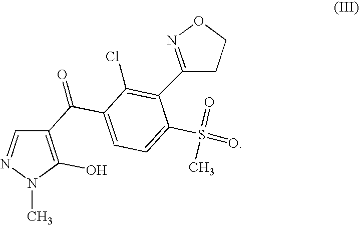

6. A composition according to claim 5 that comprises as co-herbicide atrazine, terbuthylazine, simazine, flumetsulam, metosulam, pendimethalin, clopyralid, dicamba, dicamba and diflufenzopyr, rimsulfuron, halosulfuron, diclosulam, mesotrione, isoxaflutole, diflufenzopyr or amicarbazone.

7. A composition according to claim 4 that comprises as co-herbicide terbutryne, metribuzin, pyridate, pyridafol, propoxycarbazone, glufosinate, D-glufosinate, glyphosate, sulfosate, butafenacil, butafenacil and glyphosate, fluthiacet, imazamox, imazethapyr, cloransulam, florasulam, bromoxynil, ioxynil, carfentrazone, sulfentrazone, sulcotrione, isoxachlortole, bentazone, EPTC, butylate, fentrazamide, isopropazole, aclonifen, cinidon-ethyl, flumioxacin and glyphosate, clomazone, 2,4-D, flumiclorac, sethoxydim, tepraloxydim, clethodim, imazaquin, imazapyr, thifensulfuron, prosulfuron and primisulfuron, iodosulfuron, iodo-sulfuron and isoxadifen, prohexadione, flurtamone, flumioxacin, benzfendizone, fluazolate, flufenpyr-ethyl, mesosulfuron, trifloxysulfuron or penoxsulam.

8. A composition according to claim 1 that comprises as active ingredient the mixture A consisting of metolachlor and the compound of formula II.

9. A composition according to claim 8 that comprises as active ingredient the mixture A and as co-herbicide nicosulfuron, rimsulfuron, mesotrione, prosulfuron, primisulfuron, foramsulfuron, tritosulfuron, halosulfuron or the compound of formula III.

10. A composition according to claim 1 that comprises as active ingredient the mixture B consisting of metolachlor, the compound of formula II and atrazine.

11. A composition according to claim 10 that comprises as active ingredient the mixture B and as co-herbicide nicosulfuron, rimsulfuron, mesotrione, prosulfuron, primisulfuron, foramsulfuron, tritosulfuron, halosulfuron or the compound of formula III.

12. A composition according to claim 1 that comprises as active ingredient the mixture C consisting of metolachlor, the compound of formula II and terbuthylazine.

13. A composition according to claim 12 that comprises as active ingredient the mixture C and as co-herbicide nicosulfuron, rimsulfuron, mesotrione, prosulfuron, primisulfuron, foramsulfuron, tritosulfuron, halosulfuron or the compound of formula III.

14. A composition according to claim 1 that comprises as active ingredient the mixture D consisting of metolachlor, the compound of formula II and simazine.

15. A composition according to claim 14 that comprises as active ingredient the mixture D and as co-herbicide nicosulfuron, rimsulfuron, mesotrione, prosulfuron, primisulfuron, foramsulfuron, tritosulfuron, halosulfuron or the compound of formula II.

16. A composition according to claim 1 that comprises as active ingredient the mixture E consisting of metolachlor, the compound of formula II and flumetsulam.

17. A composition according to claim 16 that comprises as active ingredient the mixture E and as co-herbicide nicosulfuron, rimsulfuron, mesotrione, prosulfuron, primisulfuron, foramsulfuron, tritosulfuron, halosulfuron or the compound of formula III.

18. A composition according to claim 1 that comprises as active ingredient the mixture F consisting of metolachlor, the compound of formula II and metosulam.

19. A composition according to claim 18 that comprises as active ingredient the mixture F and as co-herbicide nicosulfuron, rimsulfuron, mesotrione, prosulfuron, primisulfuron, foramsulfuron, tritosulfuron, halosulfuron or the compound of formula III.

20. A composition according to claim 1 that comprises as active ingredient the mixture G consisting of metolachlor, the compound of formula II and pendimethalin.

21. A composition according to claim 20 that comprises as active ingredient the mixture G and as co-herbicide nicosulfuron, rimsulfuron, mesotrione, prosulfuron, primisulfuron, foramsulfuron, tritosulfuron, halosulfuron or the compound of formula III.

22. A composition according to claim 1 that comprises as active ingredient the mixture H consisting of metolachlor, the compound of formula II and isoxaflutole.

23. A composition according to claim 22 that comprises as active ingredient the mixture H and as co-herbicide nicosulfuron, rimsulfuron, mesotrione, prosulfuron, primisulfuron, foramsulfuron, tritosulfuron, halosulfuron or the compound of formula III.

24. A composition according to claim I that comprises as active ingredient the mixture I consisting of metolachlor, the compound of formula II and mesotrione.

25. A composition according to claim 24 that comprises as active ingredient the mixture I and as co-herbicide nicosulfuron, rimsulfuron, mesotrione, prosulfuron, primisulfuron, foramsulfuron, tritosulfuron, halosulfuron or the compound of formula III.

26. A composition according to claim 1 that comprises as active ingredient the mixture J consisting of metolachlor, the compound of formula II and clopyralid.

27. A composition according to claim 26 that comprises as active ingredient the mixture J and as co-herbicide nicosulfuron, rimsulfuron, mesotrione, prosulfuron, primisulfuron, foramsulfuron, tritosulfuron, halosulfuron or the compound of formula III.

28. A composition according to claim 1 that comprises as active ingredient the mixture K consisting of metolachlor, the compound of formula II and dicamba.

29. A composition according to claim 28 that comprises as active ingredient the mixture K and as co-herbicide nicosulfuron, rimsulfuron, mesotrione, prosulfuron, primisulfuron, foramsulfuron, tritosulfuron, halosulfuron or the compound of formula III.

30. A composition according to claim 1 that comprises as active ingredient the mixture L consisting of metolachlor, the compound of formula II, dicamba and diflufenzopyr.

31. A composition according to claim 30 that comprises as active ingredient the mixture L and as co-herbicide nicosulfuron, rimsulfuron, mesotrione, prosulfuron, primisulfuron, foramsulfuron, tritosulfuron, halosulfuron or the compound of formula III.

32. A composition according to claim 1 that comprises as active ingredient the mixture M consisting of metolachlor, the compound of formula II and diclosulam.

33. A composition according to claim 32 that comprises as active ingredient the mixture M and as co-herbicide nicosulfuron, rimsulfuron, mesotrione, prosulfuron, primisulfuron, foramsulfuron, tritosulfuron, halosulfuron or the compound of formula III.

34. A composition according to claim 1 that comprises as active ingredient the mixture N consisting of metolachlor, the compound of formula II and halosulfuron.

35. A composition according to claim 34 that comprises as active ingredient the mixture N and as co-herbicide nicosulfuron, rimsulfuron, mesotrione, prosulfuron, primisulfuron, foramsulfuron, tritosulfuron, halosulfuron or the compound of formula III.

36. A composition according to claim 1 that comprises as active ingredient the mixture O consisting of metolachlor, the compound of formula II and amicarbazone.

37. A composition according to claim 36 that comprises as active ingredient the mixture O and as co-herbicide nicosulfuron, rimsulfuron, mesotrione, prosulfuron, primisulfuron, foramsulfuron, tritosulfuron, halosulfuron or the compound of formula III.

38. A composition according to claim 1 that comprises as active ingredient the mixture P consisting of metolachlor, the compound of formula II and rimsulfuron.

39. A composition according to claim 38 that comprises as active ingredient the mixture P and as co-herbicide nicosulfuron, rimsulfuron, mesotrione, prosulfuron, primisulfuron, foramsulfuron, tritosulfuron, halosulfuron or the compound of formula III.

40. A composition according to any one of claims 8 to 39 that comprises the herbicide S-metolachlor instead of metolachlor.

41. A composition according to any one of claims 8 to 39 that comprises the herbicide acetochlor instead of metolachlor.

42. A composition according to any one of claims 8 to 39 that comprises the herbicide alachlor instead of metolachlor.

43. A composition according to any one of claims 8 to 39 that comprises the herbicide flufenacet instead of metolachlor.

44. A composition according to any one of claims 8 to 39 that comprises the herbicide dimethanamid instead of metolachlor.

45. A composition according to any one of claims 8 to 39 that comprises the herbicide S-dimethenamid instead of metolachlor.

46. A composition according to any one of claims 8 to 39 that comprises the herbicide pethoxamid instead of metolachlor.

47. A method of selectively controlling weeds and grasses in crops of useful plants that comprises treating the useful plants, their seeds or cuttings or the area of cultivation thereof, simultaneously or separately, with a herbicidally effective amount of a herbicide of formula I and with an amount, effective for herbicide antagonism, of the safener of formula II.

48. A method according to claim 47 that comprises treating the the useful plants, their seeds or cuttings or the area of cultivation thereof first with a mixture of the compounds of formulae I and II and then with a co-herbicide.

49. A method according to claim 47 that comprises treating the the useful plants, their seeds or cuttings or the area of cultivation thereof first with a mixture of the compounds of formulae I and II and a co-herbicide, and then with another co-herbicide.

50. A method according to claim 47 wherein the crops of useful plants are maize.
